(19) United States
(12) Patent Application Publication
(10) Pub. No.: US 2008/0165154 A1
(43) Pub. Date: Jul. 10, 2008

(54) Apparatus and method for controlling touch sensitivity of touch screen panel and touch screen display using the same

(75) Inventor: Tae-woo Kim, Seongnam-si (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (KR)

(21) Appl. No.: 12/005,788

(22) Filed: Dec. 28, 2007

(30) Foreign Application Priority Data
Jan. 4, 2007 (KR) 10-2007-0001179

(51) Int. Cl. G06F 3/041

(52) U.S. Cl. 345/173

(57) ABSTRACT

An apparatus and method for controlling the touch sensitivity of a touch screen panel are provided. The apparatus for controlling the touch sensitivity of a touch screen panel includes a register storing a threshold value that determines the touch sensitivity of the touch screen panel, and a touch sensitivity controller changing the threshold value stored in the register on the basis of touch sensitivity control information input under the control of a user.

### CROSS-REFERENCE TO RELATED PATENT APPLICATION

This application claims priority under 35 U.S.C. 119 to Korean Patent Application No. 10-2007-0001179, filed on Jan. 4, 2007, in the Korean Intellectual Property Office, the disclosure of which is incorporated herein in its entirety by reference.

The present application is related to Korean Patent Laid-open Publication Nos. 10-2005-0061167 and 10-2004-0006566, both of which are hereby incorporated by reference in their entirety.

### FIELD OF THE INVENTION

The present invention relates to a touch screen panel display and a method of controlling the same, and more particularly, to an apparatus and method for controlling the touch sensitivity of a touch screen panel.

### BACKGROUND OF THE INVENTION

A touch screen panel display recognizes the coordinates of a point on a touch screen panel when a finger or a pen touches the point and executes an event corresponding to the recognized coordinates. Touch screen panel displays are increasingly being used instead of keypads of automated teller machines (ATM) installed in banks, as an example. Also, touch screen panel displays are increasingly being used in a personal digital assistants (PDA) and navigation systems, as other examples.

Due to research conducted into touch screen panel displays, resistive overlay type touch screen panel displays and capacitive overlay type touch screen panel displays have been developed and used.

FIG. 1 illustrates the structure of a resistive overlay type touch screen panel. A resistive overlay type touch screen panel is constructed in such a manner that a first Indium Tin Oxide (ITO) insulating layer is formed on a substrate, dot spacers for sensing touch are arranged on the first ITO insulating layer, a second ITO insulating layer is formed on the dot spacers, and a film is coated on the second ITO insulating layer.

FIG. 2 illustrates an equivalent circuit for explaining the principle of sensing a touch between the first and second ITO insulating layers illustrated in FIG. 1. Resistors R1, R2 and R3 represent resistance in the first and second ITO insulating layers according to a touch point between first and second ITO insulating layers. As illustrated in FIG. 2, at the moment when the second (upper) ITO insulating layer is touched, the coating film for detecting an X axis, which is formed on the second ITO insulating layer, and a coating film for detecting a Y axis, which is formed under the second ITO insulating layer, are electrically connected to each other. Then, a resistor R3 is electrically connected between resistors R1 and R2 at the touch point, and thus the resistance is varied to result in a change in a measured voltage. Touch data generated based on the measured voltage is compared to a threshold value to determine whether a touch is generated at the corresponding point. That is, the threshold value determines touch sensitivity.

However, a conventional touch screen panel has a fixed threshold value so that a user cannot control the touch sensitivity of the touch screen panel. That is, the touch sensitivity is set to a fixed value, and thus a touch result that the user does not intend to obtain can be generated.

Furthermore, a technique of controlling the touch sensitivity of a display device has not been developed. More particularly, a hybrid touch screen panel constructed in such a manner that touch sensors are arranged in a liquid crystal display panel so that the touch sensitivity can be user controlled has not been developed.

### SUMMARY OF THE INVENTION

In accordance with the present invention there is provided an apparatus and method for controlling the touch sensitivity of a touch screen panel, by which a user can control the touch sensitivity, and a touch screen display using the same.

In accordance with the present invention there is also provided a computer readable recording medium storing program codes for executing the method of controlling the touch sensitivity of a touch screen panel on a computer.

According to an aspect of the present invention, there is provided an apparatus for controlling the touch sensitivity of a touch screen panel, comprising a register configured to store a threshold value that determines the touch sensitivity of the touch screen panel, and a touch sensitivity controller configured to change the threshold value stored in the register on the basis of touch sensitivity control information input under the control of a user.

The touch screen panel can be a hybrid touch screen panel that comprises touch sensors arranged in a liquid crystal display panel.

The register can be configured to store an initially set threshold value of the touch sensitivity whenever a display device comprising the touch screen panel is initialized.

The apparatus can further comprise an application processor configured to generate the touch sensitivity control information in response to a touch sensitivity control event transmitted to the touch sensitivity controller in response to the touch sensitivity control information input.

The touch sensitivity controller can generate an interactive touch sensitivity control mechanism in response to the touch sensitivity control event and to change the threshold value stored in the register on the basis of touch sensitivity control data input relative to the touch sensitivity control mechanism.

The threshold value can be provided to the touch screen panel for use as a reference value for determining the generation of a touch event and a touch position in the touch screen panel.

According to another aspect of the present invention, there is provided a touch screen display comprising: a touch screen panel having a plurality of touch sensors; a display driver circuit configured to convert sensor signals generated according to positions sensed by the touch sensors, into digital data associated with touch screen positions; an application processor configured to generate touch sensitivity control information of the touch screen panel in response to control inputs from a user; and a controller. The controller is configured to change the threshold value on the basis of the touch sensitivity control information transmitted from the application processor, determine sensor data values from the digital data for each of a plurality of sets of frames corresponding to the touch screen positions, and determine differences between the digital data values corresponding to neighboring frames of the touch screen and compare the differences to the threshold value to determine the existence of a touch event and a touch position in the touch screen panel.

The touch screen panel can be a hybrid touch screen panel that comprises touch sensors arranged in a liquid crystal display panel.

The plurality of touch sensors can be arranged in an X-axis and a Y-axis and configured to generate sensor data signals relative to X-axis and Y-axis positions.

The controller can comprise a frame memory configured to store the sensor data values on a frame-by-frame basis; a buffer memory configured to store sums of digital data corresponding to neighboring frames according to X-axis and Y-axis positions associated with the touch screen panel; a register configured to store the threshold value; a touch determination unit configured to process data to be stored in the frame memory and the buffer memory, calculate differences between the sums of digital data stored in the buffer memory, and determine the generation of a touch event and a touch position in the touch screen panel on the basis of the calculated differences and the threshold value stored in the register; and a touch sensitivity controller configured to change the threshold value stored in the register on the basis of the touch sensitivity control information transmitted from the application processor under the control of the user.

The register can be configured to store an initially set threshold value of the touch sensitivity whenever the touch screen display is initialized.

The plurality of touch sensors are arranged relative to X-axis and Y-axis positions as a plurality of X-axis touch sensors and a plurality of Y-axis touch sensors and the sensor data values are stored as X-axis sensor data values and Y-axis sensor data values, and the touch determination unit can comprise a summation unit configured to sum up X-axis sensor data values and Y-axis sensor data values corresponding to N adjacent frames based on a current frame, where N is a natural number equal to or greater than 2; a subtraction and absolute value calculation unit configured to calculate absolute values of differences between the sums of the X-axis and Y-axis sensor data values obtained by the summation unit; a maximum value detector configured to detect a maximum value from the absolute values calculated by the subtraction and absolute value calculating unit; and a comparator configured to compare the maximum value detected by the maximum value detector to the threshold value stored in the register and to generate a signal representing the generation of a touch event only when the maximum value is greater than the threshold value.

The touch determination unit can further comprise a touch position detector configured to determine an X-axis position having a maximum value from the X-axis sensor data values and a Y-axis position having a maximum value of the Y-axis sensor data values, when the maximum value of the X-axis sensor data values and the maximum value of the Y-axis sensor data values are greater than the threshold value.

According to another aspect of the present invention, there is provided a method of controlling the touch sensitivity of a touch screen panel having a plurality of touch sensors. The method comprises: determining whether a touch sensitivity control event for controlling the touch sensitivity of the touch screen panel is generated; and when the touch sensitivity control event is generated, changing the touch sensitivity on the basis of touch sensitivity control information transmitted from an application processor in response to an input under the control of a user.

The changing of the touch sensitivity can comprise: transmitting an interrupt request for processing the touch sensitivity control event from the application processor to a controller controlling the touch screen panel when the touch sensitivity control event is generated; in response to the interrupt request, interrupting an instruction currently being executed and displaying a touch sensitivity control mechanism; and changing the touch sensitivity on the basis of touch sensitivity control data input according relative to the touch sensitivity control mechanism.

Changing the touch sensitivity can include varying a threshold value stored in a register, which is used to determine the generation of a touch event.

The method can further comprise initializing the touch sensitivity whenever the controller is initialized.

The method can further comprise generating the touch sensitivity control mechanism to include guide information for increasing or decreasing the touch sensitivity.

The touch screen panel can be a hybrid touch screen panel comprising touch sensors arranged in a liquid crystal display panel.

The method can further comprise increasing or decreasing the touch sensitivity in predetermined size increments based on the basis of the touch sensitivity control information.

According to another aspect of the present invention, there is provided a computer program product comprising program code stored in a computer readable recording medium and configured for execution by one or more processors to perform a method of controlling touch sensitivity of a touch screen panel having a plurality of touch sensors. The method comprises determining whether a touch sensitivity control event for controlling the touch sensitivity of the touch sensors is generated, and changing the touch sensitivity on the basis of touch sensitivity control information transmitted from an application processor under the control of a user when the touch sensitivity control event is generated.

Changing the touch sensitivity can comprise: transmitting an interrupt request for processing the touch sensitivity control event from the application processor to a controller controlling the touch screen panel when the touch sensitivity control event is generated; in response to the interrupt request, interrupting an instruction currently being executed, and displaying a touch sensitivity control mechanism image; and changing the touch sensitivity on the basis of touch sensitivity control data input relative to the touch sensitivity control mechanism image.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 illustrates the structure of a conventional resistive overlay type touch screen panel;

FIG. 2 illustrates an equivalent circuit for explaining the operating principle of the resistive overlay type touch screen panel illustrated in FIG. 1;

FIG. 3 is a block diagram of an embodiment of a touch screen display according to an aspect of the present invention;

FIG. 4 illustrates an embodiment of an arrangement of sensors of a hybrid touch screen panel according to an aspect of the present invention;

FIG. 5 is a block diagram of an embodiment of a controller illustrated in FIG. 3, according to an aspect of the present invention;

FIG. 6 is a block diagram of an embodiment of a central processing unit (CPU) illustrated in FIG. 5, according to an aspect of the present invention;

FIG. 7 illustrates data stored in a frame memory illustrated in FIG. 6, according to an aspect of the present invention;

FIG. 8 illustrates data stored in a buffer memory illustrated in FIG. 6, according to an aspect of the present invention;

FIG. 9 is a block diagram of an embodiment of a touch determination unit illustrated in FIG. 6, according to an aspect of the present invention;

FIG. 10 is a flowchart illustrating an embodiment of a method of controlling the touch sensitivity of a touch screen panel according to an aspect of the present invention; and

FIG. 11 illustrates an embodiment of a touch sensitivity control mechanism generated according to an aspect of the present invention.

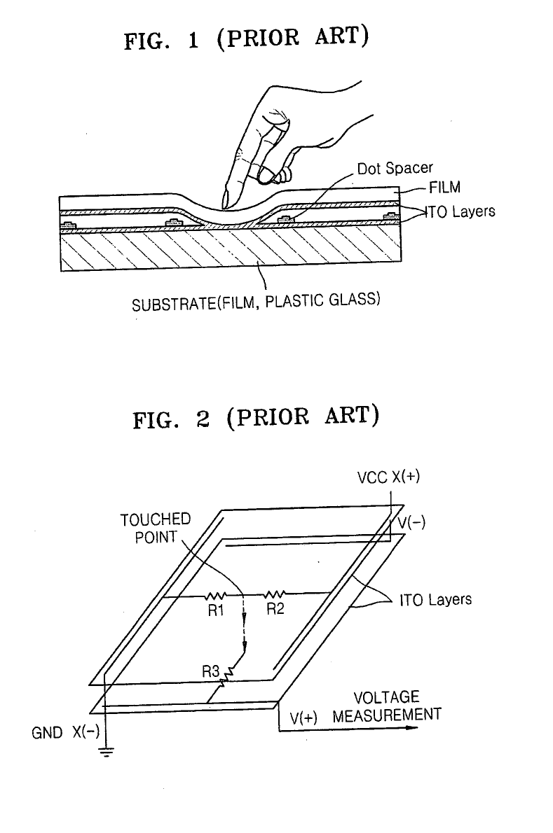

### DETAILED DESCRIPTION OF THE INVENTION

Aspects of the present invention will now be described more fully with reference to the accompanying drawings, in which exemplary embodiments are shown. The invention can, however, be embodied in many different forms and should not be construed as being limited to the embodiments set forth herein. Throughout the drawings, like reference numerals refer to like elements.

It will be understood that, although the terms first, second, etc. may be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

FIG. 3 is a block diagram of an embodiment of a touch screen panel display according to an aspect of the present invention. Referring to FIG. 3, the touch screen panel display according to the current embodiment includes a touch screen panel (TSP) 310, a display driver circuit 320, a controller 330, and an application processor (AP) 340.

The touch screen panel 310 includes a first substrate having common electrodes, a second substrate having pixel electrodes, and a liquid crystal layer interposed between the first and second substrates. The touch screen panel 310 displays an image by applying an electric field to the liquid crystal layer and adjusting the intensity of the electric field to control the quantity of light transmitted through the liquid crystal layer.

The touch screen panel 310 can comprise a hybrid touch screen panel constructed in such a manner that touch sensors are arranged in a liquid crystal display (LCD) panel. Hybrid touch screen panels have an advantage that they do not use a touch film.

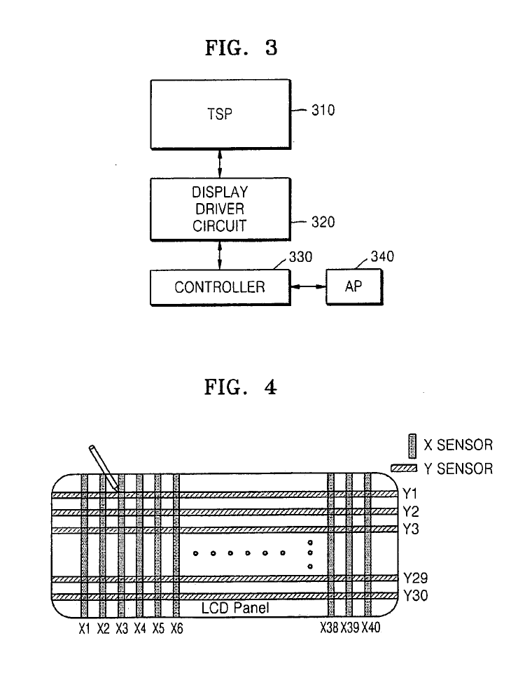

FIG. 4 illustrates an embodiment of an arrangement of touch sensors of a hybrid touch screen panel according to an aspect of the present invention. The arrangement of the touch sensors is not limited thereto and the touch sensors can be arranged in various structures in other embodiments.

The touch sensors in the LCD panel sense a point touched by a pen or a finger. That is, a touch sensor generates different sensor data values according to a touched state and an untouched state. An operation of generating a touch event and detecting a touch position will be explained later in detail.

Referring to the embodiment of FIG. 4, 40 sensor data values are generated in an X-axis and 30 sensor data values are generated in a Y-axis for each frame.

Referring back to FIG. 3, the display driver circuit 320 drives the touch screen panel 310 in response to an input image signal and various control signals to display an image. Furthermore, the display driver circuit 320 converts sensor signals according to positions, which are sensed by the touch sensors of the touch screen panel 310, into digital data and outputs the digital data to the controller 330.

The controller 330 executes various operations and control processes for generating a touch event and determining a touch position in the touch screen panel 310 using the digital data. In addition, the controller 330 performs a control process of changing a threshold value that determines the touch sensitivity based on touch sensitivity control information transmitted from the application processor 340.

The application processor 340 generates the touch sensitivity control information of the touch screen panel 310 under the control of, or in response to, the user. The controller 330 executes the control process of controlling the touch sensitivity using the touch sensitivity control information. The control process will be explained later in detail.

The illustrative operation of generating a touch event and detecting a touch point in the touch screen panel 310 will now be explained.

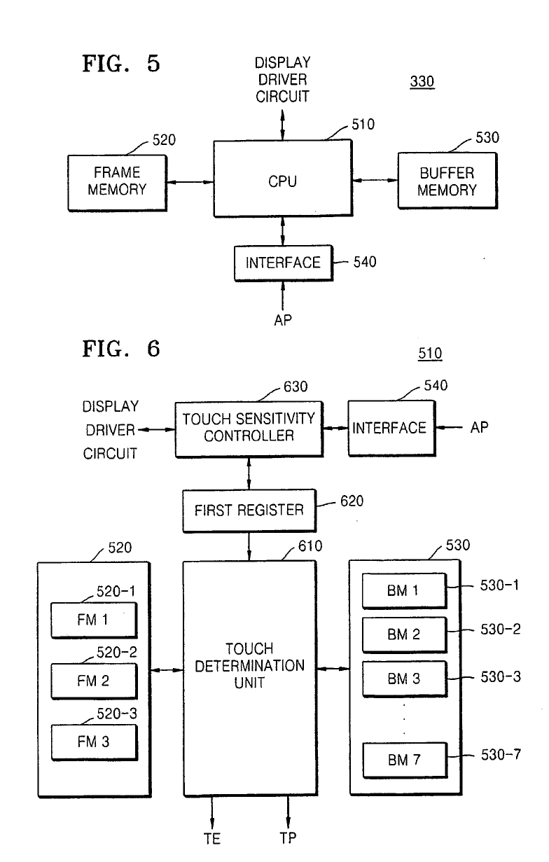

FIG. 5 is a block diagram of an embodiment of the controller 330 illustrated in FIG. 3, according to an aspect of the present invention. Referring to FIG. 5, the controller 330 includes a central processing unit (CPU) 510, a frame memory 520, a buffer memory 530, and an interface circuit 540. FIG. 6 is a block diagram of an embodiment of the CPU 510 illustrated in FIG. 5 according to an aspect of the present invention. Referring to FIG. 6, the CPU 510 includes a touch determination unit 610, a first register 620, and a touch sensitivity controller 630.

In this embodiment, the display driver circuit 320 illustrated in FIG. 3 generates 30 Y-axis sensor data values and 40 X-axis sensor data values for each frame and transmits the 70 X-axis and Y-axis sensor data values to the CPU 510 of the controller 330, when the hybrid touch screen panel illustrated in FIG. 4 is used as the touch screen panel 310.

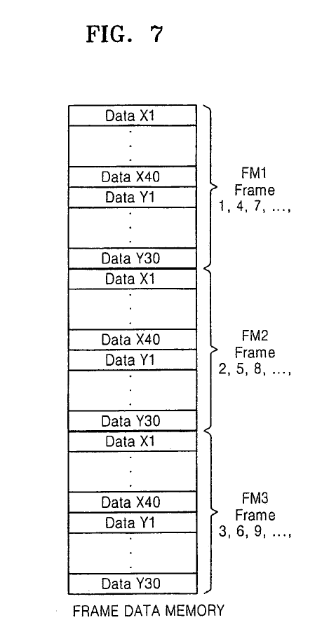

The CPU 510 stores 70 X-axis and Y-axis sensor data values generated for a first frame at addresses 0 through 69 (FM1; 520-1) of the frame memory 520. In addition, the CPU 510 stores 70 X-axis and Y-axis sensor data values generated for a second frame at addresses 70 through 139 (FM2; 520-2) of the frame memory 520 and stores 70 X-axis and Y-axis sensor data values generated for a third frame at addresses 140 through 209 (FM3; 520-3) of the frame memory 520. Accordingly, the X-axis and Y-axis sensor data values are stored in the frame memory 520, as illustrated in FIG. 7.

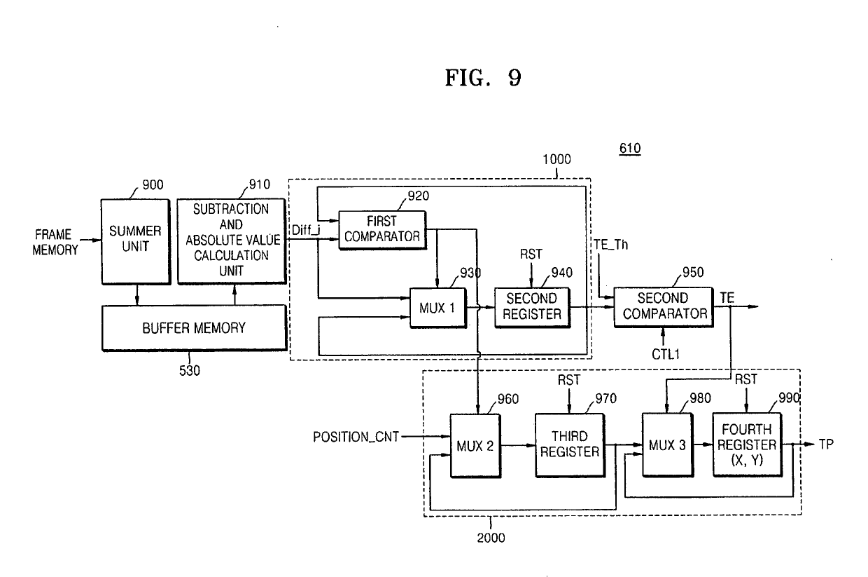

When the sensor data values corresponding to the first, second, and third frames are stored in the frame memory 520, the touch determination unit 610 of the CPU 510 executes an operation for detecting a touch event and a touch position using sensor data values read from the frame memory 520. The operation of the touch determination unit 610 will now be explained with reference to FIG. 9. FIG. 9 is a block diagram of an embodiment of the touch determination unit 610 illustrated in FIG. 6, according to an aspect of the present invention.

Referring to FIG. 9, the touch determination unit 610 includes a summation unit 900, a subtraction and absolute value calculation unit 910, a first comparator 920, a first multiplexer 930, a second register 940, a second comparator 950, a second multiplexer 960, a third register 970, a third multiplexer 980, and a fourth register 990.

The first comparator 920, the first multiplexer 930, and the second register 940 comprise a maximum value detector 1000, and the second multiplexer 960, the third register 970, the third multiplexer 980, and the fourth register 990 comprise a touch position detector 2000.

The summation unit 900 sums up X-axis and Y-axis sensor data values corresponding to neighboring N frames based on a current frame, i.e., from the sensor data values stored in the frame memory 520, by positions. N is a natural number equal to or greater than 2, wherein N is 3 in the present embodiment. That is, the summation unit 900 performs a summation on the, sensor data values corresponding to three frames read from the frame memory 520 according to the flowing Equation 1:

$$\begin{matrix}{\sum }_{Frame = 1}^{3} ( X 1 \_Data ) = Sum\_X 1 \\ {\sum }_{Frame = 1}^{3} ( X2\_Data ) = Sum\_X2 \\ ⋮ \\ {\sum }_{Frame = 1}^{3} Y 30 \_Data ) = Sum\_Y 30\end{matrix} \qquad [ Equation 1 ]$$

The summation results Sum_X1 through Sum_Y30 are stored at addresses 0 through 69 (BM1; 530-1) of the buffer memory 530 illustrated in FIG. 6.

The CPU 510 illustrated in FIG. 5 stores 70 X-axis and Y-axis sensor data values corresponding to a fourth frame at addresses 0 through 69 (FM1; 520-1) of the frame memory 520 illustrated in FIG. 6. The summation unit 900 performs a summation on sensor data values corresponding to three frames (second, third and fourth frames) read from the frame memory 520 according to the following Equation 2:

$$\begin{matrix}{\sum }_{Frame = 2}^{4} ( X 1 \_Data ) = Sum\_X 1 \\ {\sum }_{Frame = 2}^{4} ( X2\_Data ) = Sum\_X2 \\ ⋮ \\ {\sum }_{Frame = 2}^{4} Y 30 \_Data ) = Sum\_Y 30\end{matrix} \qquad [ Equation 2 ]$$

The summation results Sum_X1 through Sum_Y30 are stored at addresses 70 through 139 (BM2; 530-2) of the buffer memory 530 illustrated in FIG. 6.

This process is executed for fifth through ninth frames. Then, the summation results Sum_X1 through Sum_Y30 with respect to the seventh, eighth and ninth frames are stored at addresses 420 through 489 (BM7; 530-7) of the buffer memory 530 illustrated in FIG. 6.

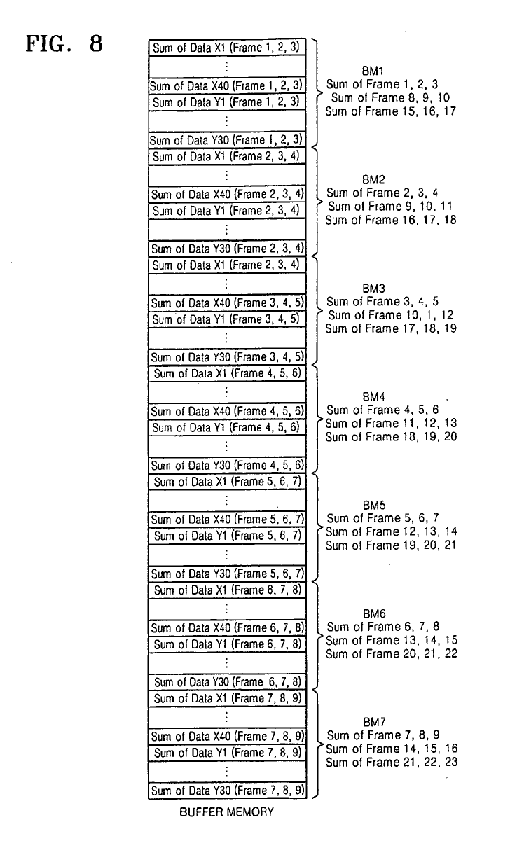

The results of the aforementioned process are stored in the buffer memory 530 as illustrated in FIG. 8.

The subtraction and absolute value calculation unit 910 calculates the absolute value of a difference between sums of X-axis and Y-axis sensor data values stored in the buffer memory 530 illustrated in FIG. 5. Specifically, in this embodiment, the subtraction and absolute value calculation unit 910 respectively subtracts the sum of the sensor data values corresponding to the first neighboring three frames (the first, second and third frames), stored at the address BM1 530-1 of the buffer memory 530 illustrated in FIG. 6, from the sum of the sensor data values corresponding to the second, third and fourth frames, stored at the address BM2 530-2 of the buffer memory 530, the sum of the sensor data values corresponding to the third, fourth, and fifth frames, stored at the address BM3 530-3 of the buffer memory 530, the sum of the sensor data values corresponding to the fourth, fifth and sixth frames, stored at the address BM4 530-4 of the buffer memory 530, the sum of the sensor data values corresponding to the fifth, sixth and seventh frames, stored at the address BM5 530-5 of the buffer memory 530, the sum of the sensor data values corresponding to the sixth, seventh and eighth frames, stored at the address BM3 530-6 of the buffer memory 530, and the sum of the sensor data values corresponding to the seventh, eighth and ninth frames, stored at the address BM3 530-7 of the buffer memory 530. These calculations are performed according to the following set of equations denoted below as Equation 3:

Sum_{—}X1 of Buffer 7−Sum_{—}X1 of Buffer 1=Diff7_{—}X1

Sum_{—}X1 of Buffer 6−Sum_{—}X1 of Buffer 1=Diff6_{—}X1

Sum_{—}X1 of Buffer 5−Sum_{—}X1 of Buffer 1=Diff5_{—}X1

Sum_{—}X1 of Buffer 4−Sum_{—}X1 of Buffer 1=Diff4_{—}X1

Sum_{—}X1 of Buffer 3−Sum_{—}X1 of Buffer 1=Diff3_{—}X1

Sum_{—}X1 of Buffer 2−Sum_{—}X1 of Buffer 1=Diff2_{—}X1

Sum_{—}X2 of Buffer 7−Sum_{—}X2 of Buffer 1=Diff7_{—}X2

Sum_{—}X2 of Buffer 6−Sum_{—}X2 of Buffer 1=Diff6_{—}X2

Sum_{—}X2 of Buffer 5−Sum_{—}X2 of Buffer 1=Diff5_{—}X2

Sum_{—}X2 of Buffer 4−Sum_{—}X2 of Buffer 1=Diff4_{—}X2

Sum_{—}X2 of Buffer 3−Sum_{—}X2 of Buffer 1=Diff3_{—}X2

Sum_{—}X2 of Buffer 2−Sum_{—}X2 of Buffer 1=Diff2_{—}X2

Sum_{—}Y30 of Buffer 7−Sum_{—}Y30 of Buffer 1=Diff7_{—}Y30

Sum_{—}Y30 of Buffer 6−Sum_{—}Y30 of Buffer 1=Diff6_{—}Y30

Sum_{—}Y30 of Buffer 5−Sum_{—}Y30 of Buffer 1=Diff5_{—}Y30

Sum_{—}Y30 of Buffer 4−Sum_{—}Y30 of Buffer 1=Diff4_{—}Y30

Sum_{—}Y30 of Buffer 3−Sum_{—}Y30 of Buffer 1=Diff3_{—}Y30

Sum_{—}Y30 of Buffer 2−Sum_{—}Y30 of Buffer 1=Diff2_{—}Y30 [Equation 3]

The subtraction and absolute value calculation unit 910 calculates the absolute values of the subtraction results calculated by equation 3.

The maximum value detector 1000 detects a maximum value from the absolute values of the X-axis sensor data values or Y-axis sensor data values, obtained by the subtraction and absolute value calculation unit 910. Specifically, the first comparator 920 respectively compares the data values Diff_i input from the subtraction and absolute value calculation unit 910 to a value stored in the second register 940. The first comparator 920 generates a first select signal when the data values Diff_i are greater than the value stored in the second register 940 and generates a second select signal when they are not.

The second register 940 is reset to ‘0’ whenever touch determination with respect to each of the data values Diff_i of the X-axis or Y-axis sensor data values is finished. When the first data value Diff7_X1 of the X-axis group is input to the first comparator 920, the first comparator 920 compares the first data value Diff7_X1 to the value stored in the second register 940. In this case, the initial value ‘0’ is stored in the second register 940, and thus the first comparator 920 outputs the first select signal.

When the first select signal is applied to the first multiplexer 930, the first multiplexer 930 selects data input from the subtraction and absolute value calculation unit 910 from input signals and outputs the selected data. The data output from the first multiplexer 930 is written to the second register 940.

When the maximum value detector 1000 sequentially processes the sensor data values Diff7_X1 through Diff1_X30 of the X-axis group, the data having the largest value from among the data values Diff7_X1 through Diff1_X30 is stored in the second register 940.

When the detection of a maximum value from the data values Diff7_X1 through Diff1_X30 of the X-axis group is finished, the CPU 510 generates a control signal CTL1. Then, the second comparator 950 compares a threshold value TE_Th read from the first register 620 illustrated in FIG. 6 to the maximum value read from the second register 940 and generates a signal TE representing the generation of a touch event only when the maximum value read from the second register 940 is greater than the threshold value TE_Th. The threshold value TE_Th is a basis for determining the touch sensitivity of the touch screen panel 310.

The touch position detector 2000 illustrated in FIG. 9 will now be explained.

The second multiplexer 960 selects one of a position counting signal POSITION_CNT and a signal stored in the third register 970 in response to the first select signal or the second select signal output from the first comparator 920. The signal selected by the second multiplexer 960 is written to the third register 970. Specifically, the second multiplexer 960 selects the position counting signal POSITION_CNT when receiving the first select signal and selects the signal read from the third register 970 when receiving the second select signal. The third register 970 is reset to ‘0’ whenever touch determination with respect to each of the data values of the X-axis group or the Y-axis group is finished.

The position counting signal POSITION_CNT is a control signal generated by the CPU 510 illustrated in FIG. 5. When data Diff_Xi is input to the maximum value detector 1000 and processed, the position counting signal POSITION_CNT has a value ‘i’. For example, the position counting signal POSITION_CNT becomes ‘2’ during a period when the data values Diff7_X2, Diff6_X2, Diff5_X2, Diff4_X2, Diff3_X2 and Diff2_X2 are input to the maximum value detector 1000.

After the maximum value detector 1000 processes the initial data Diff7_X1 of the X-axis group, the second multiplexer 960 selects the position counting signal POSITION_CNT having a value ‘1’ in response to the first select signal generated by the first comparator 920 and the position counting signal POSITION_CNT is written to the third register 970.

Accordingly, the position counting signal POSITION_CNT generated during a period when the maximum value of the data values Diff7_X1 through Diff1_X30 of the X-axis group is detected is stored in the third register 970. The value stored in the third register 970 during this period corresponds to the X-axis coordinates of the maximum value of the data values Diff7_X1 through Diff1_X30 of the X-axis group.

When the maximum value of the data values of the X-axis group is determined and the signal TE is generated by the second comparator 950, the third multiplexer 980 writes the value read from the third register 970 to an X-axis coordinate data storage region of the fourth register 990. When touch determination with respect to the X-axis group or the Y-axis group is finished, the fourth register 990 is reset such that X-axis coordinate data or Y-axis coordinate data becomes ‘0’.

A maximum value of the data signals of the Y-axis group is detected through the aforementioned process, the maximum value is compared to the threshold value TE_Th, and the signal TE representing the generation of a touch event is generated only when the maximum value is greater than the threshold value TE_Th.

The Y-axis coordinate value corresponding to the sensor position where the touch event is generated is written to a Y-axis coordinate data storage region of the fourth register 990. Accordingly, a coordinate value (X, Y) read from the fourth register 990 after the signal TE is generated according to the data signals Diff of the Y-axis group becomes touch position information TP.

According to the above-described operation, the generation of a touch event can be determined and a touch position can be detected.

In the present embodiment, the determination of the generation of a touch event is performed for both the sensor data values of the X-axis group and the sensor data values of the Y-axis group. However, it is also possible to determine whether a touch event with respect to the sensor data values of one of the X-axis and Y-axis groups is generated and then detect information about coordinates corresponding to the maximum value of the sensor data values of the other group only when the touch event is generated to detect a touch position, if required.

The second comparator 950 uses the threshold value TE_Th stored in the first register 620 as a basis for determining whether a touch event is generated in the aforementioned embodiment. The threshold value TE_Th becomes a basis of determining the touch sensitivity of the touch screen panel.

In accordance with aspects of the present invention, touch sensitivity of a touch screen panel can be controlled according to a user's choice, which will now be explained with reference to FIG. 6. FIG. 6 is a block diagram of an embodiment of the CPU 510 having a function of controlling the touch sensitivity.

Referring to FIG. 6, the first register 620 stores the threshold value TE_Th used to determine the touch sensitivity of the touch screen panel 310. An initially set threshold value is stored in the first register 620 whenever a display system including the touch screen panel 310 is initialized.

A touch sensitivity controller 630 generates a touch sensitivity control menu according to a touch sensitivity control event processing routine when a touch sensitivity control event is generated under the control of the user. In addition, the touch sensitivity controller 630 changes the threshold value TE_Th stored in the first register 620 on the basis of touch sensitivity control data transmitted from the application processor 340 illustrated in FIG. 3 according to an input relative to the touch sensitivity control mechanism.

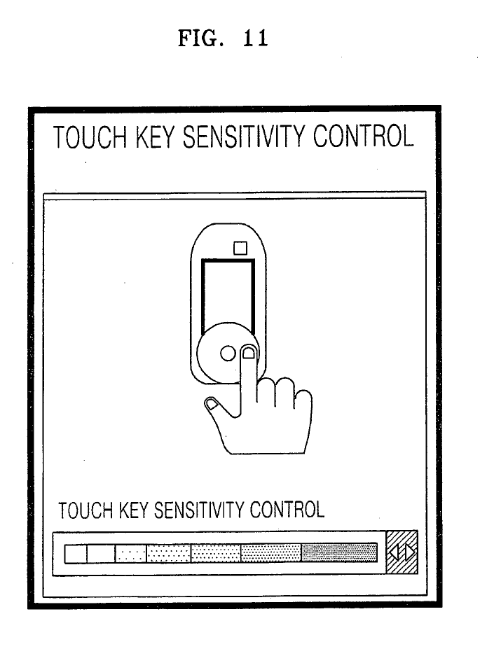

Specifically, when a user pushes a function key for controlling the touch sensitivity of the touch screen panel 310 illustrated in FIG. 3, e.g., through an input unit of an application device (not shown) including the application processor 340, the application processor 340 generates an interrupt request for processing a touch sensitivity control event and transmits the interrupt request to the interface circuit 540 illustrated in FIG. 5. Then, the touch sensitivity controller 630 generates the touch sensitivity control mechanism, as illustrated in FIG. 11, while executing the touch sensitivity control event processing routine in response to the interrupt request.

When the user pushes a touch sensitivity control key while the touch sensitivity control mechanism is generated, the application processor 340 illustrated in FIG. 3 generates touch sensitivity control data corresponding to a key value input by the user and transmits the touch sensitivity control data to the touch sensitivity controller 630 through the interface circuit 540 illustrated in FIG. 5. Then, the touch sensitivity controller 630 changes the threshold value stored in the first register 620 on the basis of the transmitted touch sensitivity control data to control the touch sensitivity.

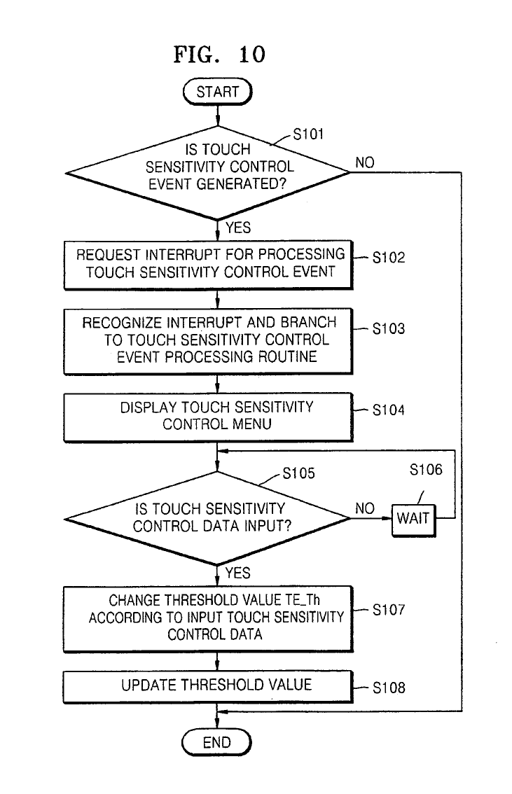

An embodiment of a method of controlling the touch sensitivity of a touch screen panel according to an aspect of the present invention will now be explained with reference to FIGS. 3, 5, 6 and 10. FIG. 10 is a flowchart illustrating a method of controlling the touch sensitivity of a touch screen panel, according to an embodiment of the present invention.

The application processor 340 determines whether a touch sensitivity control event is generated in step S101. For example, the touch sensitivity control event is generated when a user pushes a function key set in a key input unit of an application device (not shown) including the application processor 340.

When the touch sensitivity control event is generated, the application processor 340 transmits an interrupt request for processing the touch sensitivity control event to the interface circuit 540 in step S102. Then, the touch sensitivity controller 630 of the CPU 510 recognizes the interrupt request, interrupts an instruction currently being executed, and branches the process to the touch sensitivity control event processing routine in step S103.

Accordingly, the touch sensitivity controller 630 generates the touch sensitivity control mechanism according to the touch sensitivity control event processing routine and displays the touch sensitivity control mechanism on the touch screen panel 310 in step S104. For example, the touch sensitivity control mechanism can be designed in such a manner as to include guide information for increasing or decreasing the touch sensitivity, as illustrated in the embodiment of FIG. 11.

The touch sensitivity controller 630 determines whether touch sensitivity control data is input from the application processor 340 while the touch sensitivity control mechanism is displayed in step S105. When key information for increasing or decreasing the touch sensitivity is input from the key input unit of the application device while the touch sensitivity control mechanism is displayed, the application processor 340 generates touch sensitivity control data corresponding to the input key information and transmits the touch sensitivity control data to the touch sensitivity controller 630 through the interface circuit 540.

When the touch sensitivity control data is not input in step S105, the routine is fed back to step S105 after a predetermined waiting period (in step S106). When the touch sensitivity control data is input to the touch sensitivity controller 630 through the interface circuit 540 in step S105, the touch sensitivity controller 630 reads the threshold value TE_Th stored in the first register 620 and then changes the read threshold value TE_Th on the basis of the input touch sensitivity control data in step S107.

For example, the touch sensitivity controller 630 can be designed in such a manner as to decrease the threshold value TE_Th by predetermined steps whenever a key value for increasing the touch sensitivity is input and increase the threshold value TE_Th by predetermined steps whenever a key value for reducing the touch sensitivity is input.

Then, the touch sensitivity controller 630 newly writes the threshold value TE_Th changed in step S107 to the first register 620 to update the threshold value TE_Th in step S108. Accordingly, the threshold value TE_Th is stored in the first register 620 by the user, and thus the touch sensitivity can be controlled.

As described above, according to the present invention, the touch sensitivity of a touch screen panel can be controlled by a user so that the user can select the touch sensitivity most suitable to him or her. This prevents the generation of a touch result that the user does not intend to obtain.

In particular, when a recently developed hybrid touch screen panel is applied to a personal device, such as a personal digital assistant (PDA) or a navigation system, the touch sensitivity of the hybrid touch screen panel can be controlled in consideration of a user's habit of touching the touch screen panel. This prevents the generation of a touch result the user does not intend to obtain.

In accordance with aspects of the present invention, the above described functionality can also be embodied in a computer program product, as computer program code stored on one or more computer readable recording medium. The computer program code is executable by one or more processors to achieve user controllable touch screen or panel sensitivity.

The computer readable recording medium can be any storage device or system that can store data and program code, which can thereafter be read by a computer processor and/or system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While embodiments illustrating aspects of the present invention have been particularly shown and described, it will be understood by those of ordinary skill in the art that various changes in form and details can be made therein without departing from the spirit and scope of the present invention as defined by the following claims. It is intended by the following claims to claim that which is literally described and all equivalents thereto, including all modifications and variations that fall within the scope of each claim.

What is claimed is:

1. An apparatus for controlling the touch sensitivity of a touch screen panel, comprising:
a register configured to store a threshold value that determines the touch sensitivity of the touch screen panel; and
a touch sensitivity controller configured to change the threshold value stored in the register on the basis of touch sensitivity control information input under the control of a user.

2. The apparatus of claim 1, wherein the touch screen panel is a hybrid touch screen panel that comprises touch sensors arranged in a liquid crystal display panel.

3. The apparatus of claim 1, wherein the register is configured to store an initially set threshold value of the touch sensitivity whenever a display device comprising the touch screen panel is initialized.

4. The apparatus of claim 1, further comprising:
an application processor configured to generate the touch sensitivity control information in response to a touch sensitivity control event transmitted to the touch sensitivity controller in response to the touch sensitivity control information input.

5. The apparatus of claim 4, wherein the touch sensitivity controller is further configured to:
generate an interactive touch sensitivity control mechanism in response to the touch sensitivity control event; and
change the threshold value stored in the register on the basis of a touch sensitivity control data input relative to the touch sensitivity control mechanism.

6. The apparatus of claim 5, wherein the touch sensitivity controller is further configured to change the threshold value in predetermined size increments on the basis of the touch sensitivity control data.

7. The apparatus of claim 1, wherein the threshold value is provided to the touch screen panel for use as a reference value for determining the generation of a touch event and a touch position in the touch screen panel.

8. A touch screen display comprising:
a touch screen panel having a plurality of touch sensors;
a display driver circuit configured to convert sensor signals generated according to positions sensed by the touch sensors into digital data associated with touch screen positions;
an application processor configured to generate touch sensitivity control information of the touch screen panel in response to control inputs from a user; and
a controller configured to:
change the threshold value on the basis of the touch sensitivity control information transmitted from the application processor,
determine sensor data values from the digital data for each of a plurality of sets of frames corresponding to the touch screen positions, and
determine differences between the digital data values corresponding to neighboring frames of the touch screen and compare the differences to the threshold value to determine the existence of a touch event and a touch position in the touch screen panel.

9. The touch screen display of claim 8, wherein the touch screen panel is a hybrid touch screen panel that comprises touch sensors arranged in a liquid crystal display panel.

10. The touch screen display of claim 8, wherein the plurality of touch sensors are arranged in an X-axis and a Y-axis and configured to generate sensor data signals relative to X-axis and Y-axis positions.

11. The touch screen display of claim 8, wherein the controller comprises:
a frame memory configured to store the sensor data values on a frame-by-frame basis;
a buffer memory configured to store sums of digital data corresponding to neighboring frames according to X-axis and Y-axis positions associated with the touch screen panel;
a register configured to store the threshold value;
a touch determination unit configured to process data to be stored in the frame memory and the buffer memory, calculate differences between the sums of digital data stored in the buffer memory, and determine the generation of a touch event and a touch position in the touch screen panel on the basis of the calculated differences and the threshold value stored in the register; and
a touch sensitivity controller configured to change the threshold value stored in the register on the basis of the touch sensitivity control information transmitted from the application processor under the control of the user.

12. The touch screen display of claim 11, wherein the register is configured to store an initially set threshold value of the touch sensitivity whenever the touch screen display is initialized.

13. The touch screen display of claim 11, wherein the plurality of touch sensors are arranged relative to X-axis and Y-axis positions as a plurality of X-axis touch sensors and a plurality of Y-axis touch sensors and the sensor data values are stored as X-axis sensor data values and Y-axis sensor data values, and the touch determination unit comprises:
a summation unit configured to sum up X-axis sensor data values and Y-axis sensor data values corresponding to N adjacent frames based on a current frame, where N is a natural number equal to or greater than 2;
a subtraction and absolute value calculation unit configured to calculate absolute values of differences between the sums of the X-axis and Y-axis sensor data values obtained by the summation unit;
a maximum value detector configured to detect a maximum value from the absolute values calculated by the subtraction and absolute value calculating unit; and
a comparator configured to compare the maximum value detected by the maximum value detector to the threshold value stored in the register and to generate a signal representing the generation of a touch event only when the maximum value is greater than the threshold value.

14. The touch screen display of claim 13, wherein the touch determination unit further comprises a touch position detector configured to determine an X-axis position having a maximum value from the X-axis sensor data values and a Y-axis position having a maximum value of the Y-axis sensor data values, when the maximum value of the X-axis sensor data values and the maximum value of the Y-axis sensor data values are greater than the threshold value.

15. A method of controlling the touch sensitivity of a touch screen panel having a plurality of touch sensors, the method comprising:
determining whether a touch sensitivity control event for controlling the touch sensitivity of the touch screen panel is generated; and
when the touch sensitivity control event is generated, changing the touch sensitivity on the basis of touch sensitivity control information transmitted from an application processor in response to an input under the control of a user.

16. The method of claim 15, wherein the changing of the touch sensitivity comprises:
transmitting an interrupt request for processing the touch sensitivity control event from the application processor to a controller controlling the touch screen panel when the touch sensitivity control event is generated;
in response to the interrupt request, interrupting an instruction currently being executed and displaying a touch sensitivity control mechanism; and
changing the touch sensitivity on the basis of touch sensitivity control data input according relative to the touch sensitivity control mechanism.

17. The method of claim 16, wherein changing the touch sensitivity includes varying a threshold value stored in a register, which is used to determine the generation of a touch event.

18. The method of claim 15, further comprising initializing the touch sensitivity whenever the controller is initialized.

19. The method of claim 15, further comprising generating the touch sensitivity control mechanism to include guide information for increasing or decreasing the touch sensitivity.

20. The method of claim 15, wherein the touch screen panel is a hybrid touch screen panel comprising touch sensors arranged in a liquid crystal display panel.

21. The method of claim 15, further comprising increasing or decreasing the touch sensitivity in predetermined size increments based on the basis of the touch sensitivity control information.

22. A computer program product comprising program code stored in a computer readable recording medium and configured for execution by one or more processors to perform a method of controlling the touch sensitivity of a touch screen panel having a plurality of touch sensors, the method comprising:
determining whether a touch sensitivity control event for controlling the touch sensitivity of the touch sensors is generated; and
changing the touch sensitivity on the basis of touch sensitivity control information transmitted from an application processor under the control of a user when the touch sensitivity control event is generated.

23. The computer program product of claim 22, wherein changing the touch sensitivity comprises:
transmitting an interrupt request for processing the touch sensitivity control event from the application processor to a controller controlling the touch screen panel when the touch sensitivity control event is generated;
in response to the interrupt request, interrupting an instruction currently being executed, and displaying a touch sensitivity control mechanism image; and
changing the touch sensitivity on the basis of touch sensitivity control data input relative to the touch sensitivity control mechanism image.
